(19) United States
(12) Patent Application Publication
(10) Pub. No.: US 2015/0093726 A1
(43) Pub. Date: Apr. 2, 2015

(54) Systems and Methods for Tracking Learning Behavior

(71) Applicant: Technology for Autism Now, Inc., Boston, MA (US)

(72) Inventor: Marie Duggan, Roslindale, MA (US)

(21) Appl. No.: 14/284,834

(22) Filed: May 22, 2014

Related U.S. Application Data
(60) Provisional application No. 61/884,980, filed on Sep. 30, 2013.

(51) Int. Cl. G09B 5/02; G09B 19/00

(52) U.S. Cl. CPC G09B 5/02; G09B 19/00
USPC 434/156; 434/236

(57) ABSTRACT

Embodiments of the invention provide systems and methods for tracking learning behavior and teaching individuals with Autism Spectrum Disorder and other complex communication needs and learning disabilities. A demonstration of a task having a plurality of steps is provided on a graphical display of a computing device (e.g., a smartphone or tablet computer). The computing device receives an indication of any prompts or reward reminders given to the individual when the individual performs the task. Data is collected and automatically stored regarding the individual's behavior while performing the task. Upon successful completion of the task, a message of praise and/or a reward may be provided to the individual.

### CROSS-REFERENCE TO RELATED APPLICATION

This application claims priority to and the benefit of, and incorporates herein by reference in its entirety, U.S. Provisional Patent Application No. 61/884,980, which was filed on Sep. 30, 2013.

### TECHNICAL FIELD

In various embodiments, the invention relates to a system for assessing the behavior and learning ability of an individual. In particular, embodiments of the invention relate to systems and methods for tracking learning behavior and using applied behavior analysis to teach students with complex communication needs and learning disabilities.

### BACKGROUND

Autism Spectrum Disorder (ASD) is a neural development disorder characterized by a spectrum of behavioral anomalies, including impaired social interaction and communication, and repetitive or stereotyped behavior. Symptoms of ASD appear within the first few years of life and persist into adulthood. Early behavioral indicators of ASD include failure to develop normal conversational skills, avoidance of social interaction, and limited or no eye contact. Social development may be significantly delayed, with language typically failing to appear or progress normally.

Early intervention can improve the core behavioral symptoms associated with ASD children. For example, early intervention may provide an ASD child with instruction to address areas of weakness, teach new skills, and improve behaviors. Early intervention may also help family members better understand the behavior and needs of the ASD child and to interact more effectively with the child.

One type of early intervention for ASD children is Applied Behavior Analysis (ABA). ABA focuses on observable relationships between behavior and the environment and involves the application of numerous techniques for improving behavior. ABA may involve breaking skills down into their most fundamental components and rewarding good performance with praise and reinforcers. When implemented for 30-40 hours a week, ABA may help children develop language, academic, and basic living skills.

In general, however, existing approaches for early intervention with ASD children have certain deficiencies. For example, existing approaches generally fail to obtain sufficient data regarding the ASD child's learning and behavior skills, which can make it difficult to measure the child's progress and identify any changes that should be made to the teaching methods. ASD children also often find existing approaches to be uninteresting or boring, which may cause the ASD children to be less engaged and willing to participate.

There is a need for improved techniques for tracking learning behavior and teaching individuals with complex communication needs and learning disabilities.

### SUMMARY OF THE INVENTION

Embodiments of the invention provide computerized systems and methods for teaching students with complex communication needs and learning disabilities. The systems and methods facilitate the collection and distribution of data regarding the behavior and learning ability of the students. Such data makes it easy for teachers, school administrators, and parents to monitor the learning behavior and progress of the students and to identify any changes that should be made to the teaching program. The data also opens a window for teachers, school administers, and researchers to study the learning behavior of students with ASD and other communication and learning disabilities. In general, the students find the systems and methods to be more interesting than previous approaches, which improves student engagement and willingness to learn.

In one aspect, the invention relates to a computer-implemented method of measuring performance of a task. The method includes: (a) providing, on a graphical display, a description (e.g., an image and/or a text message) of at least one reward an individual may receive upon successful completion of a task having a plurality of steps; (b) receiving a selection of a preferred reward from the at least one reward; (c) providing, on the graphical display, a demonstration of the task (e.g., a video, a text message, and/or a sequence of images showing how to perform the task); (d) providing, on the graphical display, a description of at least one step in the task (e.g., a text message, an audio message, and/or an image representing or describing a step in the task); (e) receiving a prompt indicator identifying a type of prompt given to the individual during at least one step in the task; (f) receiving a reward reminder indicator identifying a type of reward reminder given to the individual during at least one step in the task; (g) receiving an indication that at least one step in the task was completed; (h) recording a time it took the individual to complete at least one step in the task; (i) automatically storing, in a register, data representing the individual's performance of the steps in the task; (j) calculating a performance metric including a plurality of statistical measurements of the individual's performance, based on the data; and (k) providing, on the graphical display, a message of praise (e.g., a text message, an audio message, an image, an animation, and/or a video praising the individual) upon successful completion of the task.

The task may be or include, for example, getting dressed, brushing teeth, preparing a meal, riding in a vehicle, traveling to a destination, going to bed, visiting a park, performing a job, doing homework, and/or using a bathroom. In some embodiments, the method includes receiving a request to view the demonstration of the task. The type of prompt may be or include, for example, a full physical prompt, a partial physical prompt, a verbal prompt, a gesture prompt, and/or no prompt. The type of reward reminder given to the individual may be or include no reward reminder (e.g., when no reward reminder is given to the individual during the task or a step).

In various embodiments, the statistical measurements include (i) a number of times the demonstration was provided on the graphical display, (ii) the prompt indicator, (iii) the reward indicator, and/or (iv) the time it took the individual to complete the at least one step in the task. The method may also include adding an additional step to the task (e.g., when a step is too difficult for the individual) and/or removing a step from the task (e.g., when a step is easy for the individual).

In another aspect, the invention relates to a system. The system includes a computer readable medium having instructions stored thereon, and a data processing apparatus configured to execute the instructions to perform operations including: (a) providing, on a graphical display, a description (e.g., an image and/or a text message) of at least one reward an individual may receive upon successful completion of a task having a plurality of steps; (b) receiving a selection of a preferred reward from the at least one reward; (c) providing, on the graphical display, a demonstration of the task (e.g., a video, a text message, and/or a sequence of images showing how to perform the task); (d) providing, on the graphical display, a description of at least one step in the task (e.g., a text message, an audio message, and/or an image representing or describing a step in the task); (e) receiving a prompt indicator identifying a type of prompt given to the individual during at least one step in the task; (f) receiving a reward reminder indicator identifying a type of reward reminder given to the individual during at least one step in the task; (g) receiving an indication that at least one step in the task was completed; (h) recording a time it took the individual to complete at least one step in the task; (i) automatically storing, in a register, data representing the individual's performance of the steps in the task; (j) calculating a performance metric including a plurality of statistical measurements of the individual's performance, based on the data; and (k) providing, on the graphical display, a message of praise (e.g., a text message, an audio message, an image, an animation, and/or a video praising the individual) upon successful completion of the task.

In certain embodiments, the operations also include receiving a request to view the demonstration of the task. The prompt may be or include, for example, a full physical prompt, a partial physical prompt, a verbal prompt, a gesture prompt, and/or no prompt. In some instances, the statistical measurements include (i) a number of times the demonstration was provided on the graphical display, (ii) the prompt indicator, (iii) the reward indicator, and/or (iv) the time it took the individual to complete the at least one step in the task.

In another aspect, the invention relates to a computer program product stored in one or more storage media for improving language translation through incentivized feedback. The computer program product is executable by the data processing apparatus, thereby causing the data processing apparatus to perform operations including: (a) providing, on a graphical display, a description (e.g., an image and/or a text message) of at least one reward an individual may receive upon successful completion of a task having a plurality of steps; (b) receiving a selection of a preferred reward from the at least one reward; (c) providing, on the graphical display, a demonstration of the task (e.g., a video, a text message, and/or a sequence of images showing how to perform the task); (d) providing, on the graphical display, a description of at least one step in the task (e.g., a text message, an audio message, and/or an image representing or describing a step in the task); (e) receiving a prompt indicator identifying a type of prompt given to the individual during at least one step in the task; (f) receiving a reward reminder indicator identifying a type of reward reminder given to the individual during at least one step in the task; (g) receiving an indication that at least one step in the task was completed; (h) recording a time it took the individual to complete at least one step in the task; (i) automatically storing, in a register, data representing the individual's performance of the steps in the task; (j) calculating a performance metric including a plurality of statistical measurements of the individual's performance, based on the data; and (k) providing, on the graphical display, a message of praise (e.g., a text message, an audio message, an image, an animation, and/or a video praising the individual) upon successful completion of the task.

In certain embodiments, the operations also include receiving a request to view the demonstration of the task. The prompt may be or include, for example, a full physical prompt, a partial physical prompt, a verbal prompt, a gesture prompt, and no prompt. In some embodiments, the statistical measurements include (i) a number of times the demonstration was provided on the graphical display, (ii) the prompt indicator, (iii) the reward indicator, and/or (iv) the time it took the individual to complete the at least one step in the task.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a flowchart of a method of teaching an individual, in accordance with certain embodiments of the invention;

FIG. 2 is a screenshot of exemplary data obtained and summarized in accordance with certain embodiments of the invention;

FIG. 3 is a screenshot of a welcome screen, in accordance with certain embodiments of the invention;

FIG. 4 is a screenshot of a task selection screen, in accordance with certain embodiments of the invention;

FIG. 5 is a screenshot of a reward selection screen, in accordance with certain embodiments of the invention;

FIG. 6 is a screenshot of a demonstration screen, in accordance with certain embodiments of the invention;

FIG. 7 is a screenshot of a step description screen, in accordance with certain embodiments of the invention;

FIG. 8 is a screenshot of a praise screen, in accordance with certain embodiments of the invention;

FIG. 9 is a screenshot of a reward screen, in accordance with certain embodiments of the invention; and

FIG. 10 is a schematic diagram of a computer system and network, in accordance with certain embodiments of the invention.

### DETAILED DESCRIPTION

It is contemplated that systems, methods, and processes of the claimed invention encompass variations and adaptations developed using information from the embodiments described herein. Adaptation and/or modification of the systems, methods, and processes described herein may be performed by those of ordinary skill in the relevant art.

Throughout the description, where systems are described as having, including, or comprising specific components, or where processes and methods are described as having, including, or comprising specific steps, it is contemplated that, additionally, there are systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

In certain embodiments, computerized systems and methods are provided for tracking and assessing the behavior of an individual (e.g., a student) while the individual performs a task having a plurality of steps. The task may be any type of task but is preferably associated with common day-to-day activities of ordinary individuals. The task may be, for example, getting dressed, brushing teeth, preparing a meal, riding in a vehicle, traveling to a destination (e.g., on a bus or airplane), going to bed, visiting a park, using a bathroom, doing a job, doing homework, shopping at a store (e.g., a grocery store), and visiting the beach. The systems and methods may utilize, include, or be based at least partially on ABA.

In a typical implementation, the individual receives information from and/or interacts with a computing device, such as a personal computer, a laptop computer, a tablet computer, or a smartphone. The computing device records data as the individual performs the task, and the data may be distributed and/or presented to facilitate review of the individual's behavior and progress.

The individual may be any person but is preferably a person having a complex communication need and/or a person who struggles with learning new tasks. The individual may be, for example, a person with ASD, Down syndrome, a traumatic brain injury (e.g., due to physical trauma, sepsis, or a stroke), mental retardation, or aphasia.

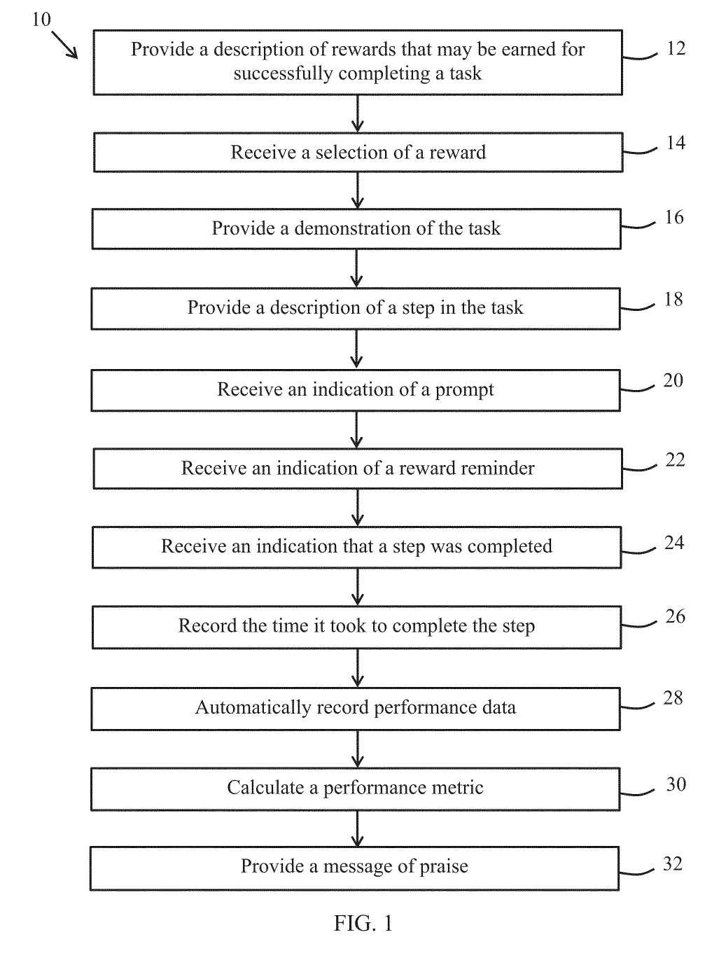

FIG. 1 is a flowchart of a method 10 for teaching an individual (e.g., a child with ASD), in accordance with certain embodiments of the invention. The method is implemented on a computing device (e.g., a tablet computer or a smartphone) and includes providing (step 12) (e.g., on a graphical display of the computing device) a description (e.g., a picture and/or text) of one or more rewards the individual may receive upon successful completion of a task. The reward options may include, for example, food (e.g., candy), use of a toy, use of an electronic device (e.g., a smartphone), or watching a video. The task preferably has more than one step and typically includes from about 2 to about 10 steps, or from about 4 to about 8 steps. The individual may then choose a preferred reward, and the selection of the preferred reward is received (step 14) by the computing device. The individual has an opportunity to view a demonstration of the task, which may be provided (step 16), for example, as a video, text, images, and/or audio. The individual may watch the demonstration one or more times, or may choose to skip the demonstration.

When the individual is ready to begin performing the task, a description (e.g., an image and/or text) of a step in the task is provided (step 18). The individual may then begin performing the task. For example, if the task is brushing teeth, the description of the step in the task may indicate that the individual should obtain a toothbrush, and the individual may then attempt to locate and obtain a physical toothbrush, which is preferably made available to the individual. For the next step, the description may indicate that the individual should obtain toothpaste, and the individual may then attempt to locate and obtain a tube of toothpaste. Additional steps in the tooth brushing task may include, for example, putting toothpaste on the toothbrush, brushing top and bottom teeth, rinsing the individual's mouth, and rinsing the toothbrush.

When performing any step in the task, the individual may become distracted or confused and may require assistance. To provide guidance and/or keep the individual focused on the task, a supervisor (e.g., a teacher or parent) may provide a prompt to the individual. The prompt may be, for example, a full physical prompt, a partial physical prompt, a verbal prompt, and/or a gesture. In certain instances, a full physical prompt occurs when the supervisor provides full physical contact (e.g., guiding the individual's hand or arm) to guide the individual through the step. In some instances, a partial physical prompt occurs when the supervisor provides partial physical assistance (e.g., tapping the individual on the shoulder) to guide the individual through the step. A verbal prompt may occur when supervisor provides verbal guidance to the individual (e.g., a spoken response to a question asked by the individual, or a verbal reminder), to assist the individual with the step. A gestural prompt may occur when the supervisor provides a gesture (e.g., pointing, nodding the head, or shaking the head) or other motion that the individual may view and use for guidance when performing the step. In some instances, the individual is able to complete the step with no prompt being provided. For one or more steps, or for each step, an indication of the type of prompt performed by the supervisor is received (step 20) by the computing device. For example, the supervisor may select an icon or button on the graphical display of the computing device to indicate the type of prompt used.

In a typical case, the supervisor prefers to avoid the use of prompts or, if a prompt is required, prefers to use a prompt with a low intensity (e.g., a gestural prompt rather than a full physical prompt). In some instances, however, more intense prompts (e.g., full physical prompts) may be helpful, for example, to build the confidence of a new student.

To further keep the individual focused on the task at hand, the supervisor may periodically (e.g., one or more times during the task or each step) remind the individual about the reward that will be given to the individual upon successful completion of the task. The reward reminder generally encourages the individual to regain focus and attempt to complete the task. For each reward reminder given, an indication that the reward reminder was given is received (step 22) by the computing device. For example, after giving a reward reminder, the supervisor may select an icon or button on the graphical display of the computing device to indicate that the reward reminder was given. In some implementations, the reward reminder is considered to be a type of prompt.

When the individual completes a step in the task, an indication that the step has been completed is received (step 24) by the computing device. For example, the supervisor may provide input to the computing device (e.g., by selecting a button or icon on the graphical display) to indicate that the step has been completed. The time it took the individual to complete the step is then recorded (step 26) by the computing device.

During the task, data representing the individual's performance is collected and stored automatically (step 28). For example, the computing device may store the following: the number of times the demonstration of the task was provided on the graphical display, the number of times the individual requested to view the demonstration of the task, the types of prompts, if any, performed by the supervisor during each step of the task, the number of times the reward reminder was given to the individual during the task and/or each step in the task, and the time it took the individual to complete the task and/or each step in the task. The data may be stored remotely on the computing device and/or on a remote storage device accessed through a network. In some embodiments, the data is stored locally (e.g., on the computing device) when no network connection is available and then copied or transferred to a remote storage device once a network connection is established.

In general, the data includes or defines a plurality of statistical measurements that are used to calculate (step 30) a performance metric for the individual. For example, statistical measurements of how often the individual completes tasks or steps successfully, the types of prompts required, the rewards chosen, the time it takes to complete certain steps, etc., may be used to compute the performance metric. The performance metric may provide an indication of the individual's progress or ability to learn the task, or the individual's behavior or effort when performing the task or steps in the task. The performance metric may be used to refine the techniques used to teach the individual or other individuals.

Once the individual completes the task, a message of praise is provided (step 32) to the individual. For example, the computing device may present a text message, an audio message, an image, an animation, and/or a video praising the individual for a job well done. The message of praise may be provided after the computing device receives an indication from the supervisor that the task has been completed.

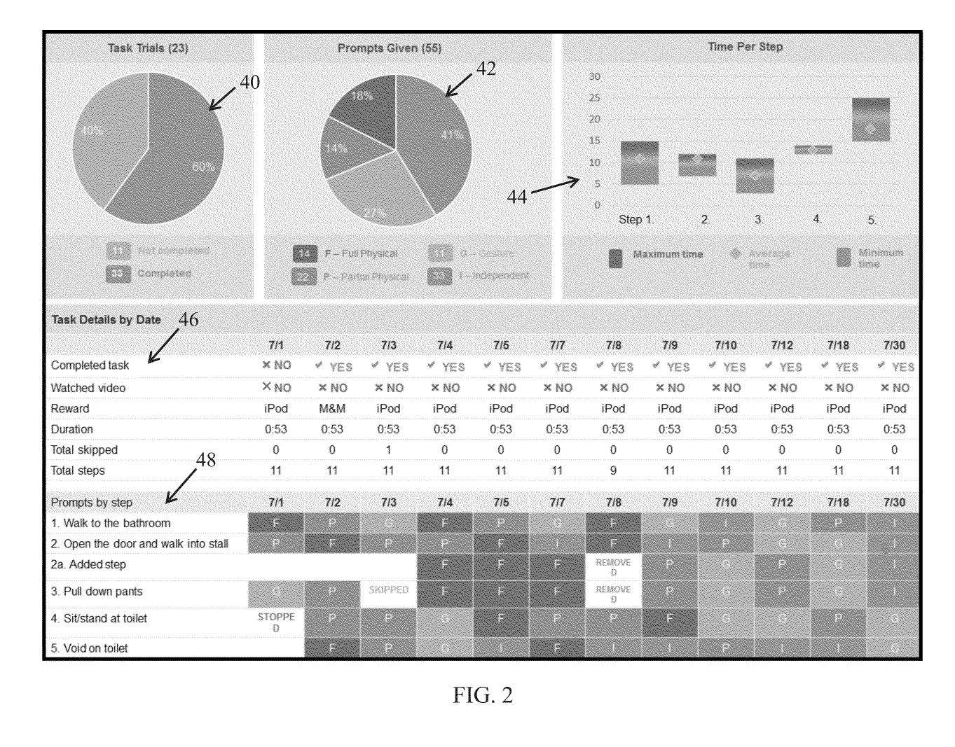

FIG. 2 includes a screenshot of an exemplary data summary that may be obtained in accordance with the systems and methods described herein. The data in this case relates to an individual's repeated attempts at performing the task of entering and using a bathroom, over the course of a prior time period. A pie chart 40 indicates how often the individual was able to complete the task successfully. Another pie chart 42 shows a distribution of the various prompts (e.g., full physical prompt F, partial physical prompt P, a gesture prompt G, and no prompt or independent I) that were given to assist the individual with the task. A bar graph 44 shows the time it took the individual to perform each step in the task. The maximum, minimum, and average times are provided for each step.

A table 46 in the figure organizes the data according to the dates when the individual performed the task. For each date, the table indicates: whether the individual completed the task, if the individual watched a video (i.e., a demonstration of the task), the reward chosen by the individual, the duration or total time it took to complete the task, the number of steps the individual skipped, if any, and the total number of steps performed. Another table 48 summarizes the prompts given to the individual for each step on the different dates. As indicated, in some instances, the individual skipped a step or stopped performing the task.

In some implementations, the data collected by the systems and methods described herein is accessible to various personnel, including teachers, school administrators (e.g., at the local and district levels), and parents. The data storage system may assign certain data privileges to the personnel. For example, parents may be able to view data only for the individual, teachers may be able to view data only for individuals the teachers are instructing, and school administrators (e.g., a school principal) may able to view data for all individuals at a school.

Advantageously, the systems and methods described herein greatly facilitate the collection, distribution, and analysis of data related to learning and behavior, particularly for individuals with complex communication needs and or learning disabilities. For example, the data may be easily reviewed by teachers and/or parents to assess progress made by an individual and to identify areas where the individual is performing well and where the individual is not performing well. The data also facilitates review of teaching techniques to identify any changes in the teaching techniques that may be necessary. Given that the data may be recorded and made available for review as the individual is performing a task or shortly thereafter, the individual's performance and progress can be monitored regularly (e.g., hourly or daily, and in real-time or near real-time) by teachers, parents, and school administrators. For example, a parent may be able to access the data remotely to check on the progress and activities of a child during the school day. The automatic collection of and easy access to the data improves dramatically the overall learning experience of the individual.

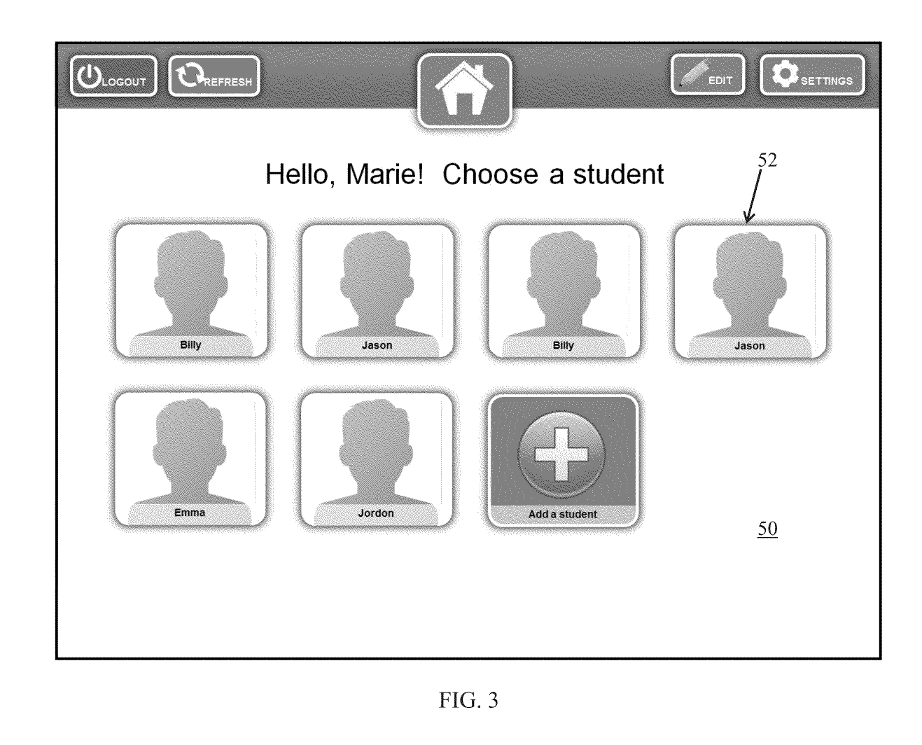

FIGS. 3 through 9 include screenshots from exemplary embodiments of the systems and methods described herein. Referring to FIG. 3, a supervisor may access a welcome screen 50 in which a listing of students or individuals is presented. The supervisor may select one of the students by tapping or clicking on an image 52 of the student. The supervisor also has the option of adding new students to the listing or removing students from the listing, for example, as students enroll in or graduate from a school or teaching program.

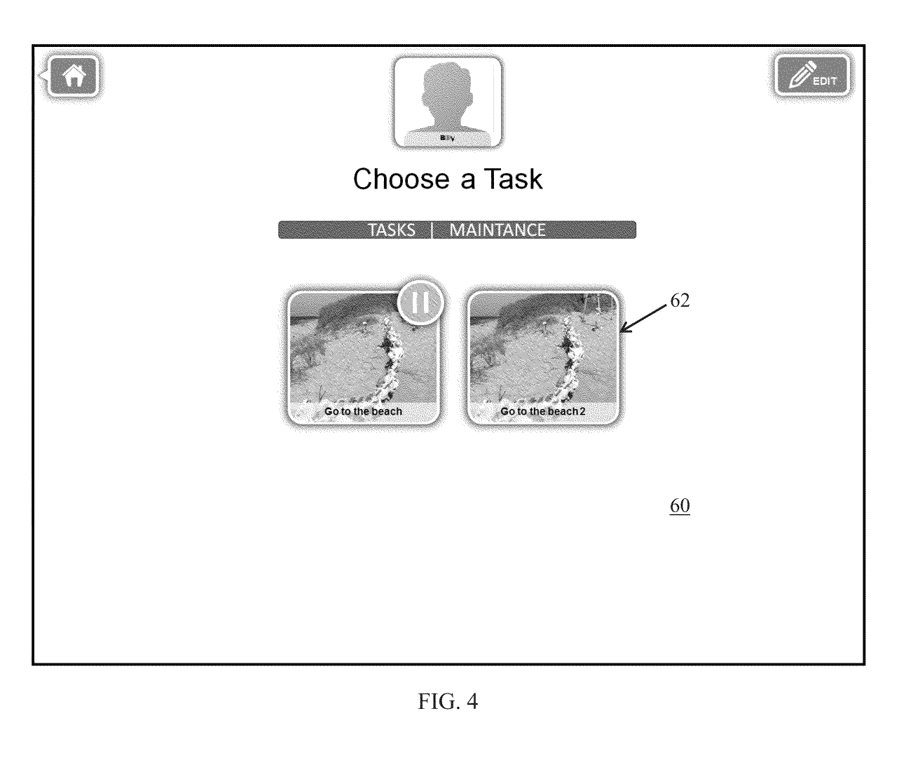

Referring to FIG. 4, the supervisor may be presented with a task selection screen 60 having a listing of possible tasks for the student. The supervisor may select one of these tasks by tapping or clicking on an image 62 of the task. The supervisor is preferably able to edit tasks or create new tasks, as appropriate, depending on the needs of the students. For example, the supervisor may record a video, record audio, take pictures, and/or add text for a new task (e.g., visiting a playground) or a new step. The supervisor may then incorporate the video, audio, pictures, and/or text into the description of the new task or step for use with the systems and methods described herein.

Additionally, in some instances, the supervisor may wish to adjust the number of steps in the task, according to the individual's ability to perform the task. For example, if the individual is able and willing to perform a particular step repeatedly and efficiently, with no prompt or reward reminder necessary, the supervisor may decide to remove that step from the task. This way, the individual may be considered to have learned the step and can skip the step the next time the task is performed. Alternatively, if a step has proven to be too difficult for the individual, the supervisor may add an intermediate step or divide the step into two or more steps. For example, if an individual is having difficulty with a step that involves applying toothpaste to a toothbrush, the supervisor may divide the step into multiple steps (e.g., obtain a toothpaste tube, remove the cap from the toothpaste tube, and squeeze the toothpaste onto the toothbrush). The individual will then be asked to perform the new, smaller steps the next time the task is performed, which should make the task easier for the individual.

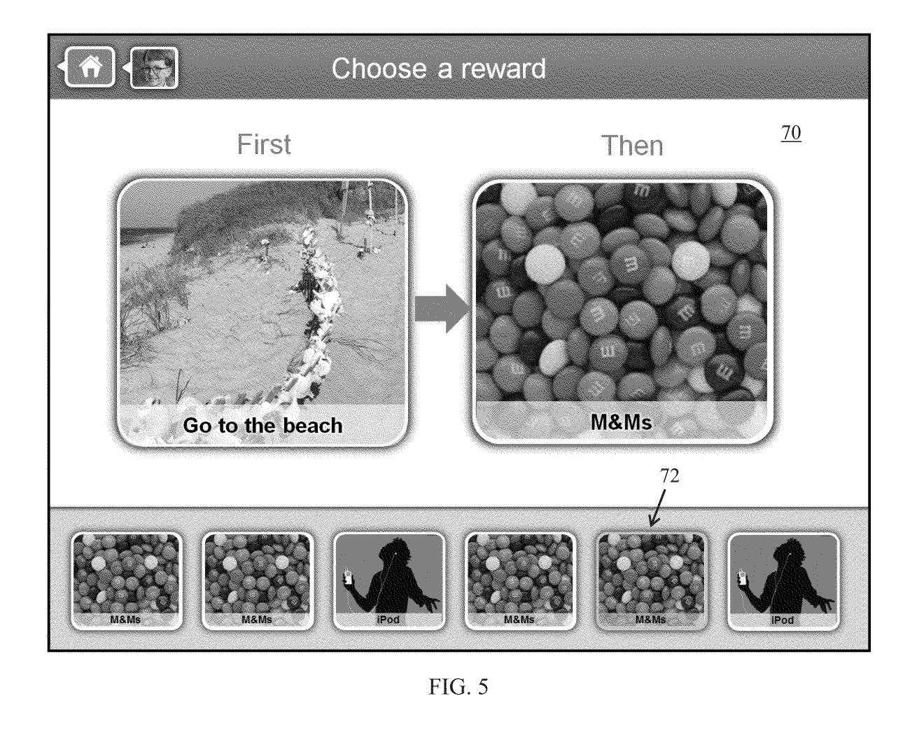

Referring to FIG. 5, the supervisor may be presented with a reward selection screen 70 having a listing of possible rewards that the student may earn upon successful completion of the task. The supervisor or student may select one of these rewards by tapping or clicking on an image 72 of the reward. The supervisor may add or remove rewards according to the options available to the supervisor and the needs of the student. For example, if the supervisor obtains a new toy, the supervisor can add the new toy as a possible reward. Additionally, when a student consistently chooses the same reward (e.g., candy), the supervisor can remove that reward as one of the options for the student, if the supervisor does not want the student to receive that particular reward going forward.

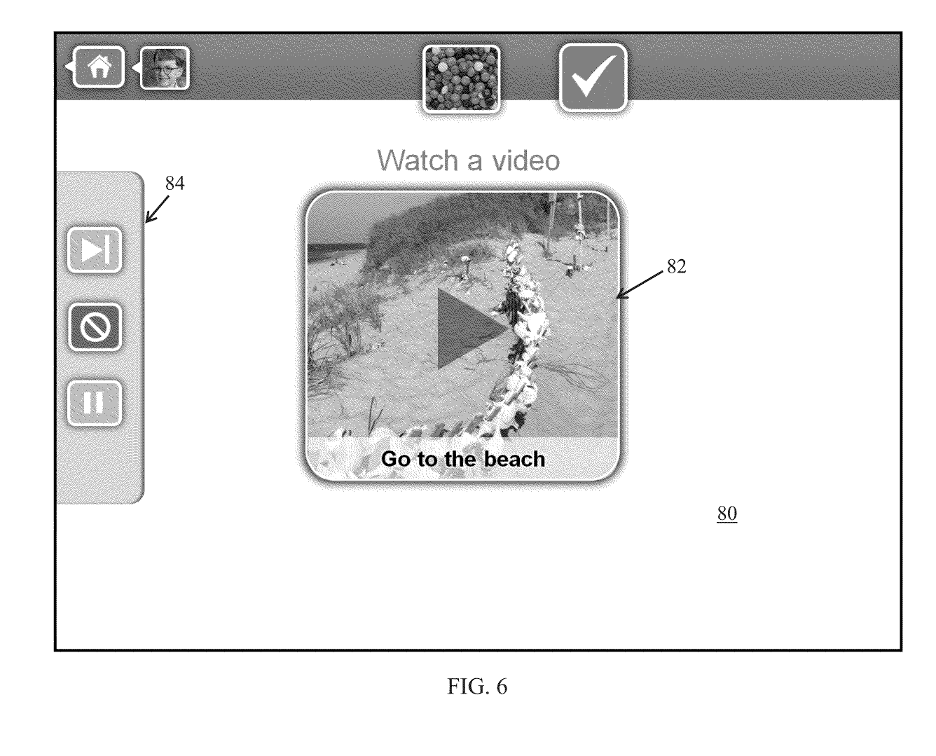

Referring to FIG. 6, the student and/or supervisor may be presented with a demonstration screen 80 that provides the student with an opportunity to see a demonstration (e.g., a video) of the task. The demonstration may be viewed by tapping or clicking on an icon 82 representing the demonstration. Controls 84 for the demonstration are provided that allow the supervisor or student to pause and re-start the demonstration.

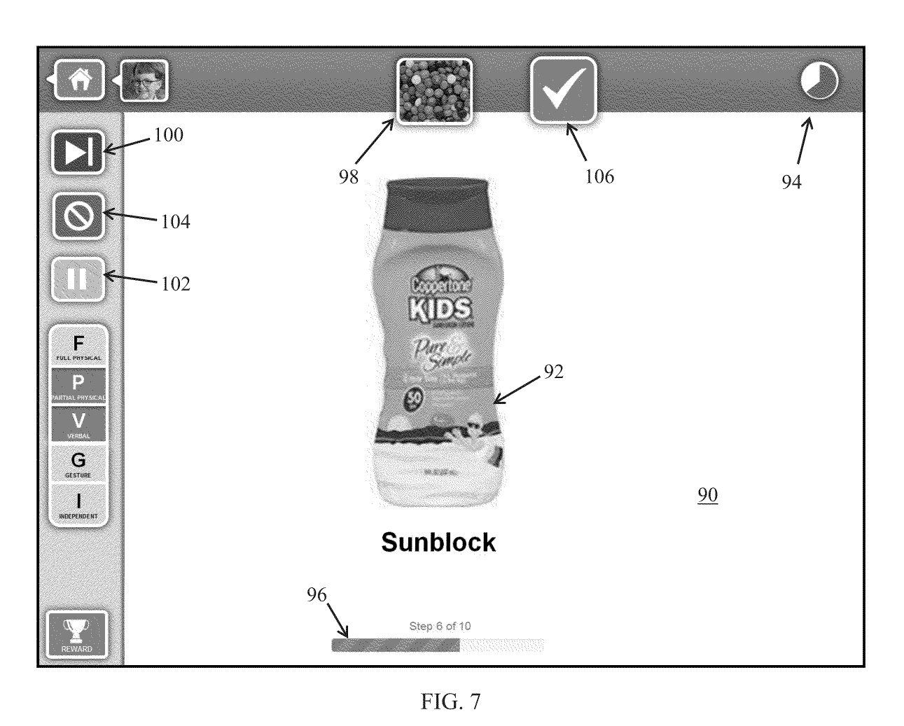

Referring to FIG. 7, the student and/or supervisor may be presented with a step description screen 90 that provides a description of the next step in the task. In the depicted example, the task is a visit to the beach, and the next step requires the student to obtain sunblock. Accordingly, an image of sunblock 92 is presented on the graphical display, along with the word “sunblock.” A timer icon 94 is displayed showing the elapsed time for the task and the amount of time remaining for the student to complete the task. In a typical situation, the student is given about 10 minutes or from about 5 minutes to about 20 minutes to complete the task. The timer icon may display the time in an analog format or in a digital format, depending on the preferences of the supervisor or student. A progress bar 96 indicates the progress the student has made in performing the task. The progress bar 96 may indicate the number of steps completed and the number of steps remaining in the task.

As mentioned, if the student becomes confused or distracted while performing the step, the supervisor may provide a prompt to the student. In that case, the supervisor may select an icon representing the type of prompt provided (e.g., a full physical prompt F, a partial physical prompt P, a verbal prompt V, a gesture prompt G, and no prompt or independent I). Alternatively or additionally, the supervisor may remind the student about the reward by selecting a reward symbol 98. Selecting the reward symbol 98 may cause a description of the reward (e.g., an image and/or text) to be presented.

If the student wishes to watch the demonstration of the step or task, the demonstration may be viewed by selecting a play icon 100. The demonstration may then be paused by selecting a pause icon 102. For example, the student may need to view only a portion of the demonstration corresponding to the current step being performed by the student.

If the student becomes non-compliant or otherwise refuses to participate in the step or task, the supervisor may select a “universal no” symbol 104. In that case, the reward symbol 98 may be replaced by an image of the universal no symbol, to indicate that the reward may no longer be available to the student.

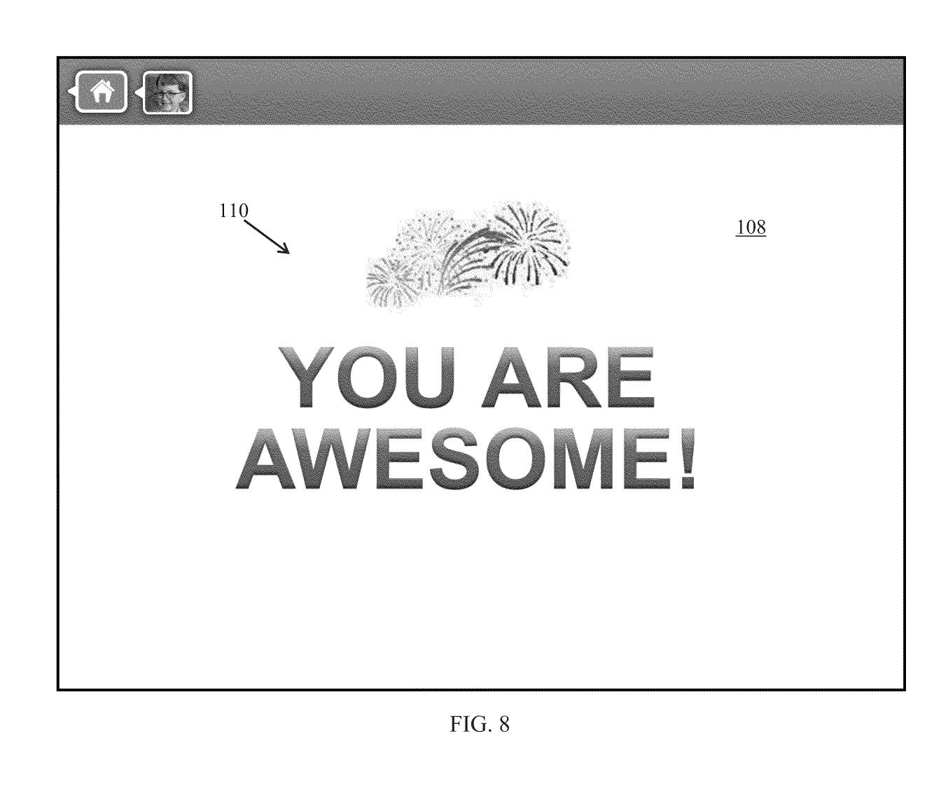

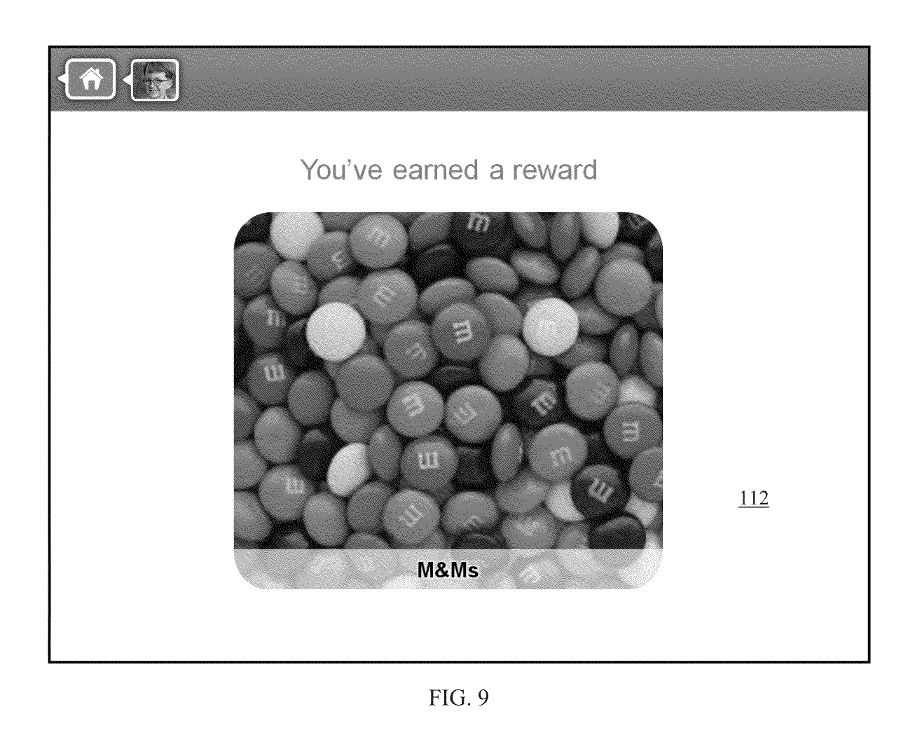

When the student completes the task, a completion symbol 106 may be selected. Referring to FIG. 8, the student and/or supervisor may then be presented with a praise screen 108 that includes a message of praise 110 for the student. The specific text, images, and animation, if any, in the message of praise 110 are fully customizable and may be specified or designed (e.g., by the supervisor) to suit the needs of the supervisor and/or the student. Referring to FIG. 9, a reward screen 112 may be presented that indicates the student has earned the chosen reward.

In various embodiments, the systems and methods described herein provide tools for facilitating the assessment and comparison of compliance and task learning behaviors among individuals having a variety of learning disabilities. The tools allow task learning abilities and learning behavior to be identified for these individuals, according to physical age, mental age, gender, learning disability, and learning profile. The tools also allow for earlier diagnosis of learning disabilities and more effective intervention to address these disabilities. The data obtained using the systems and methods described herein may be reviewed by teachers, parents, and/or school administrators to monitor an individual's learning trajectory and behavioral profile over time. Emotional triggers or learning triggers may be identified for individuals, based on patterns observed in the data.

It is understood that the methods and systems described herein may contain software and hardware connected to the Internet via a network. Computing devices are capable of communicating with each other via the Internet, and it should be appreciated that the various functionalities of the components may be implemented on any number of devices.

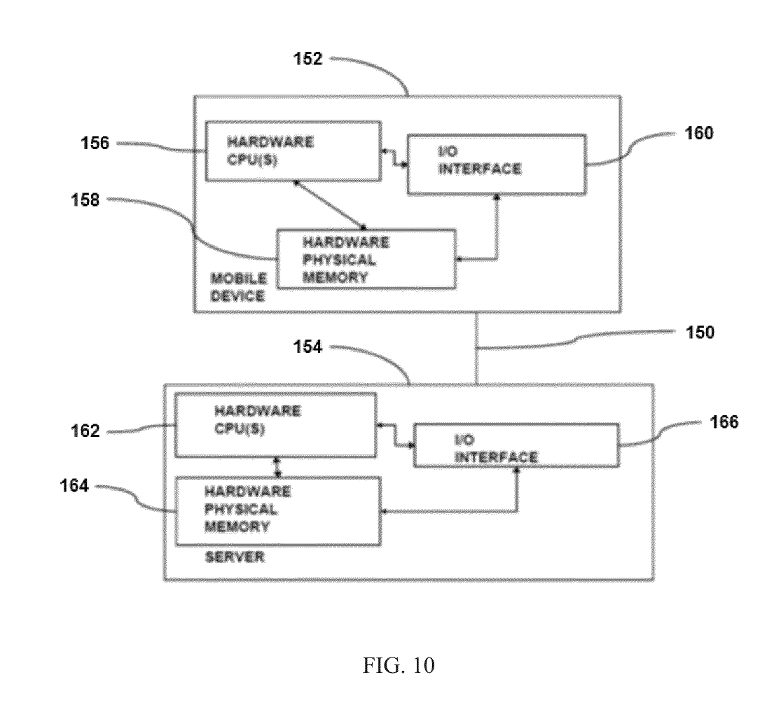

Referring to FIG. 10, a communications network 150 generally connects a mobile device 152 or other device (e.g., a personal computer, a tablet computer, or a workstation) with a server 154, and in the case of peer to peer communications, connects two peers. The communication may take place via any media such as standard telephone lines, LAN or WAN links (e.g., T1, T3, 56 kb, X.25), broadband connections (ISDN, Frame Relay, ATM), wireless links (802.11, Bluetooth, etc.), and so on. Preferably, the network can carry TCP/IP protocol communications, and HTTP/HTTPS requests made by a web browser and the connection may be made between the peers and communicated over such TCP/IP networks.

The type of network is not a limitation, however, and any suitable network may be used. Non-limiting examples of networks that can serve as or be part of the communications network include a wireless or wired Ethernet-based intranet, a local or wide-area network (LAN or WAN), and/or the global communications network known as the Internet, which may accommodate many different communications media and protocols.

Mobile device 152 and server(s) 154 may be implemented in any suitable way. FIG. 10 illustrates an exemplary architecture for the mobile device 152 and the server 154 that may be used in some embodiments. The mobile device 152 may include hardware central processing unit(s) (CPU) 156, operatively connected to hardware/physical memory 158 and input/output (I/O) interface 160. Exemplary server 154 similarly comprises hardware CPU(s) 162, operatively connected to hardware/physical memory 164 and input/output (I/O) interface 166. Hardware/physical memory may include volatile and/or non-volatile memory. The memory may store one or more instructions to program the CPU to perform any of the functions described herein. The memory may also store one or more application programs.

Exemplary mobile device 152 and exemplary server 154 may have one or more input and output devices. These devices can be used, among other things, to present a user interface and/or communicate (e.g., via a network) with other devices or computers. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Those skilled in the art will appreciate that the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide such functionality, for example as a database management system which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory includes at least one set of instructions that is either permanently or temporarily stored. The processor executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, RUM and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed microprocessor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations described herein are intended as illustrative and in no way limiting.

What is claimed is:

1. A computer-implemented method of measuring performance of a task, the method comprising:
(a) providing, on a graphical display, a description of at least one reward an individual may receive upon successful completion of a task comprising a plurality of steps;
(b) receiving a selection of a preferred reward from the at least one reward;
(c) providing, on the graphical display, a demonstration of the task;
(d) providing, on the graphical display, a description of at least one step in the task;
(e) receiving a prompt indicator identifying a type of prompt given to the individual during at least one step in the task;
(f) receiving a reward reminder indicator identifying a type of reward reminder given to the individual during at least one step in the task;
(g) receiving an indication that at least one step in the task was completed;
(h) recording a time it took the individual to complete at least one step in the task;
(i) automatically storing, in a register, data representing the individual's performance of the steps in the task;
(j) calculating a performance metric comprising a plurality of statistical measurements of the individual's performance, based on the data; and
(k) providing, on the graphical display, a message of praise upon successful completion of the task.

2. The method of claim 1, wherein the description of the at least one reward comprises at least one of an image and a text message.

3. The method of claim 1, wherein the task is selected from the group consisting of getting dressed, brushing teeth, preparing a meal, riding in a vehicle, traveling to a destination, going to bed, visiting a park, performing a job, doing homework, and using a bathroom.

4. The method of claim 1, wherein the demonstration of the task comprises at least one of a video, a text message, and a sequence of images.

5. The method of claim 1, further comprising receiving a request to view the demonstration of the task.

6. The method of claim 1, wherein the description of the at least one step in the task comprises at least one of a text message, an audio message, an image representing the task.

7. The method of claim 1, wherein the type of prompt is selected from the group consisting of a full physical prompt, a partial physical prompt, a verbal prompt, a gesture prompt, and no prompt.

8. The method of claim 1, wherein the type of reward reminder comprises no reward reminder.

9. The method of claim 1, wherein the statistical measurements comprise (i) a number of times the demonstration was provided on the graphical display, (ii) the prompt indicator, (iii) the reward indicator, and (iv) the time it took the individual to complete the at least one step in the task.

10. The method of claim 1, wherein the message of praise comprises at least one of a text message, an audio message, an image, an animation, and a video.

11. The method of claim 1, further comprising adding an additional step to the task.

12. The method of claim 1, further comprising removing a step from the task.

13. A system comprising:
a computer readable medium having instructions stored thereon; and
a data processing apparatus configured to execute the instructions to perform operations comprising:
(a) providing, on a graphical display, a description of at least one reward an individual may receive upon successful completion of a task comprising a plurality of steps;
(b) receiving a selection of a preferred reward from the at least one reward;
(c) providing, on the graphical display, a demonstration of the task;
(d) providing, on the graphical display, a description of at least one step in the task;
(e) receiving a prompt indicator identifying a type of prompt given to the individual during at least one step in the task;
(f) receiving a reward reminder indicator identifying a type of reward reminder given to the individual during at least one step in the task;
(g) receiving an indication that at least one step in the task was completed;
(h) recording a time it took the individual to complete at least one step in the task;
(i) automatically storing, in a register, data representing the individual's performance of the steps in the task;
(j) calculating a performance metric comprising a plurality of statistical measurements of the individual's performance, based on the data; and
(k) providing, on the graphical display, a message of praise upon successful completion of the task.

14. The system of claim 13, the operations further comprising receiving a request to view the demonstration of the task.

15. The system of claim 13, wherein the prompt is selected from the group consisting of a full physical prompt, a partial physical prompt, a verbal prompt, a gesture prompt, and no prompt.

16. The system of claim 13, wherein the statistical measurements comprise (i) a number of times the demonstration was provided on the graphical display, (ii) the prompt indicator, (iii) the reward indicator, and (iv) the time it took the individual to complete the at least one step in the task.

17. A computer program product stored in one or more storage media for improving language translation through incentivized feedback, the computer program product being executable by the data processing apparatus to cause the data processing apparatus to perform operations comprising:
(a) providing, on a graphical display, a description of at least one reward an individual may receive upon successful completion of a task comprising a plurality of steps;
(b) receiving a selection of a preferred reward from the at least one reward;
(c) providing, on the graphical display, a demonstration of the task;
(d) providing, on the graphical display, a description of at least one step in the task;
(e) receiving a prompt indicator identifying a type of prompt given to the individual during at least one step in the task;
(f) receiving a reward reminder indicator identifying a type of reward reminder given to the individual during at least one step in the task;
(g) receiving an indication that at least one step in the task was completed;
(h) recording a time it took the individual to complete at least one step in the task;
(i) automatically storing, in a register, data representing the individual's performance of the steps in the task;
(j) calculating a performance metric comprising a plurality of statistical measurements of the individual's performance, based on the data; and
(k) providing, on the graphical display, a message of praise upon successful completion of the task.

18. The computer program product of claim 17, the operations further comprising receiving a request to view the demonstration of the task.

19. The computer program product of claim 17, wherein the prompt is selected from the group consisting of a full physical prompt, a partial physical prompt, a verbal prompt, a gesture prompt, and no prompt.

20. The computer program product of claim 17, wherein the statistical measurements comprise (i) a number of times the demonstration was provided on the graphical display, (ii) the prompt indicator, (iii) the reward indicator, and (iv) the time it took the individual to complete the at least one step in the task.
